(19) United States
(12) Patent Application Publication
(10) Pub. No.: US 2012/0054686 A1
(43) Pub. Date: Mar. 1, 2012

(54) COMPOSITE ATTRIBUTE CONTROL METHOD AND PORTABLE DEVICE THEREOF

(75) Inventors: Jong Sung JOO, Seoul (KR); Joon Ho WON, Gyeonggi-do (KR); Ho Ik HWANG, Gyeonggi-do (KR); Byeong Cheol HWANG, Seoul (KR); Chul Min CHOI, Seoul (KR); Se Jin KWAK, Seoul (KR)

(73) Assignee: SAMSUNG ELECTRONICS CO., LTD., Gyeonggi-Do (KR)

(21) Appl. No.: 13/215,429

(22) Filed: Aug. 23, 2011

(30) Foreign Application Priority Data
Aug. 25, 2010 (KR) 10-2010-0082548

(51) Int. Cl. G06F 3/048

(52) U.S. Cl. 715/835

(57) ABSTRACT

Provided is a method for controlling a composite attribute of a portable device, including receiving an input signal for controlling a composite attribute, checking an application program activated according to the reception of the input signal, and checking at least one composite attribute defined in the application program, outputting an attribute control matrix interface in which the checked plurality of attributes are arranged based on a given axis of matrix.

### CLAIM OF PRIORITY

This application claims, pursuant to 35 USC 119, priority to, and the benefit of the earlier filing date of, that patent application filed in the Korean Patent Office entitled “Composite Attribute Control Method and Portable Device Thereof,” filed on Aug. 25, 2010 and afforded serial number 10-2010-0082548, the contents of which are incorporated by reference, herein.

### BACKGROUND OF THE INVENTION

1. Field of the Invention

The present invention relates to a portable device, and more particularly, to a user interface.

2. Description of the Related Art

With the rapid development of multiple technologies being incorporated into portable devices, today's portable devices can perform multiple functions other than being a simple communication device. For example, today's portable devices can also incorporate functions or operations such as a videotelephony function, a digital organizer function, and an internet function as well as a simple voice call function and a short message transmission function. The portable device makes use of hardware and software to support various functions. That is, today's portable devices are able to support the operation of various applications programs based on the hardware having a high processing power. Today's portable devices are operated based on various attribute values when executing each application program. For instance, a portable device may include specific attributes which are controllable for the taste or the liking of the user, while the user can control specific attributes of audio signal of music file when the application program for playing music file is activated so as to carter to the user's taste or liking. For instance, when the portable device has an attribute value of various sound effects in advance, a user may control the selection of attribute values of an audio signal associated with a music file being played. Or the user may select one or more specific attribute values for a desired music file. In the meantime, the attribute of sound which a user can select indicates a universal attribute value that may be generalized with a genre attribute of tag information that a music file generally includes or by predicting an expected effect of user. Accordingly, since the attribute control of user means a selection of detailed expression value that an audio signal of music file actually expresses and an attribute value which are critically generalized with a personal preference that cannot be generalized for each user, it is difficult to select an attribute value in detail that a user wants or desires. Furthermore, the conventional user attribute control has a disadvantage in that it should be individually controlled even when the attribute value is classified in detail. Thus, there is a need for a method so that a normal user, i.e., one who is not a power user, can easily change attributes of a device, even when the attribute critical to the operation of the device.

### SUMMARY OF THE INVENTION

The present invention has been made in view of the above problems, and provides a composite attribute control method of a portable device that supports the ability of the user to easily recognize and select various attributes applied to a corresponding application program according to the activation of application program of portable device.

The present invention further provides a composite attribute control method of portable device capable of providing a user interface by which user can change and recognize the control of user attribute, and a portable device thereof.

In accordance with an aspect of the present invention, a method, operable in a processor, for controlling a composite attribute of a portable device includes receiving an input signal for controlling a composite attribute, checking an application program activated according to the reception of the input signal; and checking at least one composite attribute defined in the application program, outputting an attribute control matrix interface in which the checked plurality of attributes are arranged based on a given axis of matrix.

In accordance with another aspect of the present invention, a portable device includes at least one of an input unit and a touch panel generating an input signal for a composite attribute control and a display unit outputting an attribute control matrix interface in which at least one composite attribute defined in an application program activated by a reception of the input signal is arranged based on a given axis of matrix.

In the present invention, according to a composite attribute control method of portable device and a portable device thereof, a user can more rapidly and easily control the attribute since the user can control the attributes defined in a specific application program.

Furthermore, since the present invention can more rapidly recognize the effect of controlled attribute, the operation of the portable device can be more easily performed.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of a portable device according to an exemplary embodiment of the present invention;

FIG. 2 is a flowchart illustrating a composite attribute control method according to an exemplary embodiment of the present invention;

FIGS. 3 and 4 are screens for illustrating an example of an audio composite attribute control according to an exemplary embodiment of the present invention;

FIG. 5 is a screen for illustrating another example of an audio composite attribute control according to an exemplary embodiment of the present invention;

FIG. 6 is a screen for illustrating an example of a screen composite attribute control according to an exemplary embodiment of the present invention;

FIG. 7 is a screen for illustrating another example of a screen composite attribute control according to an exemplary embodiment of the present invention;

FIG. 8 is a screen for illustrating an example of a camera composite attribute control according to an exemplary embodiment of the present invention;

FIG. 9 is a screen for illustrating another example of a camera composite attribute control according to an exemplary embodiment of the present invention; and

FIG. 10 is a screen for illustrating an example of a control of a plurality of composite attributes according to an exemplary embodiment of the present invention.

### DETAILED DESCRIPTION OF THE INVENTION

The following description with reference to the accompanying drawings is provided to assist in a comprehensive understanding of exemplary embodiments of the invention as defined by the claims and their equivalents. The description includes various specific details to assist in that understanding but these specific details are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

Hereinafter, an exemplary embodiment of the present invention is illustrated in detail with reference to attached drawings.

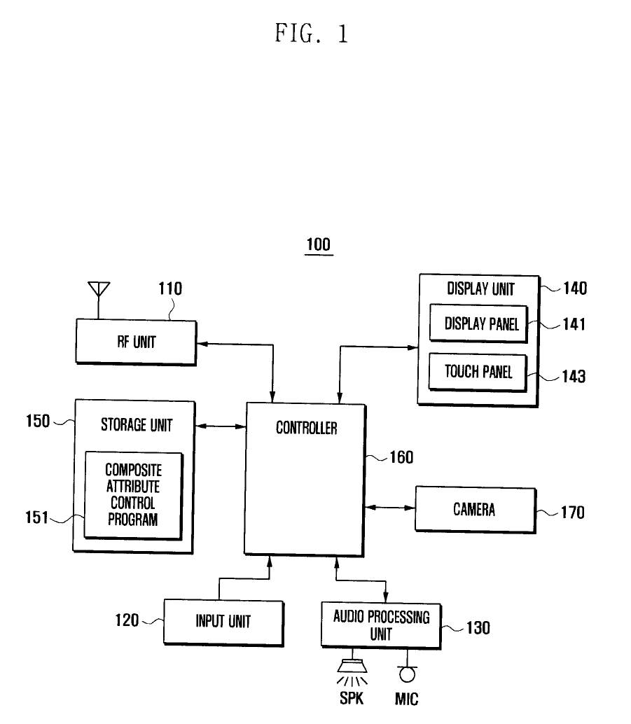

FIG. 1 is a block diagram illustrating a part of configuration related with a composite attribute control of the present invention among a configuration of a portable device according to an exemplary embodiment of the present invention.

Referring to FIG. 1, the portable device 100 of the present invention may include a radio frequency unit 110, an input unit 120, an audio processing unit 130, a display unit 140, a storage unit 150, a camera 170 and a controller 160. Here, the camera 170 of the portable device 100 is an element added to explain the composite attribute control of application program of the present invention. Therefore, it should be understood that the composite attribute technology of the present invention can be applied to other application programs even in case of the portable device that does not include the camera 170 or includes features that are not illustrated. The present invention having such a configuration can support complex control of the attributes defined in a corresponding application program, when loading and activating an application program from the storage unit 150, which are necessary for the operation of each element of the portable device 100 to support the activating of the application program. To this end, the portable device 100 can provide a user interface for the composite attribute control and a specific menu screen. Hereinafter, each element of the portable device 100 illustrated is described in detail. The radio frequency unit 110 performs a communication channel formation for voice call, a communication channel formation for audio and/or videotelephony, and a communication channel formation for the transmission of data like image or message under the control of the controller 160. That is, the radio frequency unit 110 forms a voice call communication channel, a data communication channel, and a video telephony channel between mobile communication systems. To this end, the radio frequency unit 110 may include a radio frequency transmission unit which up-converts and amplifies the frequency of the signal being transmitted and a radio frequency receiving unit that low-noise amplifies and down-converts the frequency of a received signal. The radio frequency unit 110 may receive data through a formed channel, and the received data can be outputted to the display unit 140 under the control of the controller 160. Further, the radio frequency unit 110 may receive various data from outside under the control of user, and may send the data to the storage unit 150 under the control of the controller 160. Particularly, in case the radio frequency unit 110 is operated based on a call function, the portable device 100 supports the control of attributes related with the call function. That is, a voice call channel is formed based on the radio frequency unit 110, the portable device 100 may control the output of an attribute control matrix interface in which the attributes form an axis of a specific coordinate so as to present specific attributes of voice transmitting and receiving in a voice call panel, e.g., a treble-base attribute and a background sound processing attribute. Here, the treble attribute may mean that the processing of a high-pitched tone that has a relatively higher frequency among audio signals is more finely controlled than a low-pitched sound or a sound volume of high-pitched tone is allocated more. Similarly, a base attribute may mean that the processing of a sound that has a relatively low frequency band among audio signals is more finely performed or a weight of low-pitched sound is increased through an additional volume allocation. A background sound processing attribute or a scene attribute may be an attribute that enable a user to more clearly listen to a corresponding audio signal by assigning a higher weight to background music or sound which is different from a speaker's conversation among audio signals.

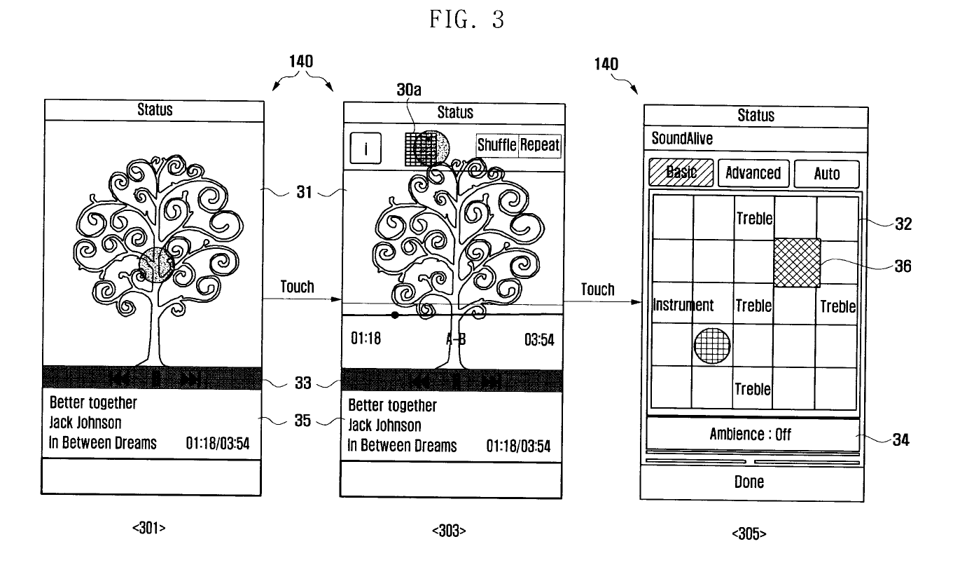

In the case a videotelephony channel is formed based on the radio frequency unit 110, the portable device 100 can control an attribute control matrix interface that can simultaneously control the attribute related with the quality of an image, e.g., the attribute related with the size and sharpness of image, and the brightness and shade of image, to the display unit 140. The input unit 120 includes a plurality of input keys and function keys that receive an input of number or character information and set various functions. The function keys may include a direction key, a side key and a shortcut key, which are set to perform a specific function. Moreover, the input unit 120 generates a key signal that is inputted in association with a user setting and a function control of the portable device 100 to send to the controller 160. In particular, the input unit 120 can generate an input signal for calling an attribute control matrix interface, and can generate an input signal for designating a specific composite attribute value according to the user control in the state where the attribute control matrix interface is called and a corresponding screen is outputted to the display unit 140. The input unit 120 generates the input signal to send to the controller 160. The audio processing unit 130 includes a speaker (SPK) for playing an audio data transmitting and receiving in the videotelephony or voice call, a music file or an audio data of video file, and a mike (MIC) for collecting the voice of user in the videotelephony or other audio signal. Attribute values designated in the attribute control matrix interface can be reflected to the audio data outputted in the audio processing unit 130 on a real time basis. Accordingly, a user can immediately recognize the changing attribute values of audio data being outputted through the operation for the attribute value control. The display unit 140 displays information which user inputs or information provided to the user as well as various menus of the portable device 100. That is, the display unit 140 can provide various screens according to the use of portable device 100, e.g., a stand-by screen, a menu screen, a message writing screen, a call screen, a portable device exit screen, and a portable device booting screen. This display unit 140 can be formed as a flat display panel using technologies such as a liquid crystal display (LCD), an organic light emitted diode (OLED) and a light emitting diode (LED) or other similar types of display technologies. The above-described display unit 140 can be comprised of a display panel 141 and a touch panel 143. Particularly, among the display unit 140, the attribute control matrix screen of the present invention is outputted to the display panel 141 while an area setting is accomplished in the touch panel 143 so as to correspond to the matrix screen, so that the display unit 140 can configure an attribute control matrix interface. The attribute control matrix interface outputted to the above-described display unit 140 is described later in detail with reference to FIGS. 3 to 9.

The display panel 141 is arranged in the upper or lower portion of the touch panel 143, and can output an image stored in the storage unit 150. And the display panel 141 can output data received from outside to screen. Moreover, the display panel 141 may output a message received from a source external to the screen. Various screens which are outputted in the display panel 141 can be formed of a scene image already stored in the storage unit 150. Particularly, the display panel 141 of the present invention can output a screen corresponding to one for activating an application. An attribute control icon for the attribute control matrix interface for a call can be outputted, as a default screen or according to a user control, on one side of the screen which is outputted in the display panel 141 in response to the corresponding application program. When the attribute control icon is selected or activated, the display panel 141 can output the attribute control matrix interface for various attribute control of the activating application. At this time, when the attributes to be adjusted to the composite attribute among the various attributes of the application program are multiple, the display panel 141 can output a menu screen which has items corresponding to composite attributes so that user may select a specific composite attribute. Here, items corresponding to the composite attributes may be outputted with a list type or may be outputted with an icon type. That is, the display panel 141 can output a menu screen which supports to select composite attributes which integrate some attribute among attributes defined in a specific application program, and an attribute control matrix screen for a corresponding composite attribute control according to a specific composite attribute selection. Here, in case the composite attribute defined in the application program exists only once, the display panel 141 may omit the output of a menu screen for the selection of composite attribute. The touch panel 143 may be arranged in the upper or lower portion of the display panel 141 to generate a touch event according to the operation of user touch, and can send the generated touch event to the controller 160. This touch panel 143 can be implemented through various methods, e.g., a resistance film method or a capacitor method, for example. The touch panel 143 collects a signal generated according to a pressure generated in the surface or an access of object, information of location in which signal is generated, and send the collected information to the controller 160 so that it can sense that the touch event has been generated. Particularly, when the attribute control matrix screen is outputted in the display panel 141, the touch panel 143 can perform an area segmentation to classify the area of each panel according to the area unit corresponding to a corresponding matrix area. Thereafter, when a touch event is generated in a specific location on the area segmented touch panel 143, the controller 160 recognizes the matrix screen area value of the display panel 141 as the composite attribute control value according to the touch event sent from the touch panel 143, and, accordingly, can perform a composite attribute application process. The storage unit 150 stores a screen image to be outputted to the display unit 140 as well as an application program necessary for the operation of a function according to an exemplary embodiment of the present invention, and may store a key map for the operation of the touch screen or a menu map, and information of a touch lock part or a cancel area when the display unit 140 is configured on the touch screen. Here, the key map and the menu map can have various types. That is, the key map can be a keyboard map, 3*4 key map, or a QWERTY key map, and can be a control key map for the operation control of the activating application program. Moreover, the menu map can be a menu map for the operation control of activating one or more application programs. This storage unit 150 may include a program area and a data area. The program area can store an operating system (OS) for the booting of the portable device 100 and the operation of each of the above described configuration, and various application, e.g., an application program for the call function support of the portable device 100, a web browser for connecting to an internet server, a MP3 application program for playing an audio selection, an image output application program for reproducing a picture, a video playing application program, and a camera operating program. Particularly, the program area of the present invention can store a composite attribute control program 151. The composite attribute control program 151 includes routines that support the operation of a composite attribute control of a specific application program when the specific application program is activated after the portable device 100 is turned-on.

That is, the composite attribute control program 151 includes a routine which controls the output of an attribute control icon for the attribute control matrix interface call to one side of the display unit 140, a routine which confirms the composite attributes of the application program being activated according to the attribute control icon selection, a routine which outputs a menu screen for the selection of specific composite attribute among composite attributes when the composite attribute is plural, a routine which outputs the attribute control matrix interface corresponding to a pertinent composite attribute when the composite attribute is singular or a specific composite attribute is selected in the menu screen, a routine which obtains an input signal generated in the state where the attribute control matrix interface is outputted or a specific composite attribute control value according to touch event, applies the obtained composite attribute control value to the activating application program, and a routine which controls to change the image of the attribute control icon according to the controlled composite attribute value. The data area (not shown) is an area in which data generated according to the use of portable device 100 is stored, can store a phone book data, at least one icon according to the widget function, and various contents. Particularly, the data area can store various data for supporting the activation of various application programs of the portable device 100. For example, when a music file play program exists in the portable device 100, a music file can be stored in the data area. Moreover, the data area can store an image file, and a video file. These files are fetched according to the activation of an appropriate application program stored in the program area and supports the generation, and outputting, of an audio signal or a video signal according to the corresponding application program. The camera 170 provides a function of collecting an image of specific subject according to user control. To this end, the camera 170 includes a camera sensor converting an optical signal into an electric signal, and an image signal processor converting an analog video signal into a digital video signal, and can send the video signal outputted from the image signal processor to the controller 160. Here, a charge-coupled device (CCD) sensor or a complementary metal-oxide semiconductor (CMOS) sensor can be used as the camera sensor, and the configuration of the signal processing unit can be omitted and can be implemented as a Digital Signal Processor (DSP). When the activation of the setting control of the camera 170 is selected according to the user control, the camera application program stored in the storage unit 150 is loaded in the controller 160 and controls various setting of the camera 170. At this time, when a pre-stored setting value related with the camera 170 exists, the controller 160 can automatically set the camera 170 environment according to a corresponding set value. Particularly, the controller 160 can output the attribute control matrix interface which can control the attributes of the camera 170 to the display unit 140 so that it may conveniently support various attribute definitions of the camera 170. Accordingly, a user can simultaneously control the brightness and contrast of the camera 170, the chroma and sharpness, the image quality and size, and the white balance and EV, for example. Here, a menu screen that contains an item corresponding to composite attributes may be outputted so that a user may select one of the above-described composite attributes for the control of composite attributes of the camera 170. In the meantime, the configuration of the camera 170 may be omitted when the portable device 100 does not support a corresponding function. The controller 160 controls the electric power supply to each element of the portable device 100 to perform the initialization of each element. The controller 160 can perform various screens and signal processing for the composite attribute control according to an exemplary embodiment of the present invention.

In more detail, in the electric power supply of the portable device 100, the controller 160 completes a booting and can output a screen according to the activation of specific application program, e.g., a background screen, depending on preset schedule information. At this time, the controller 160 can output an attribute control icon to one side of the screen for the support of a function that can change the background attribute. When user selects a corresponding attribute control icon, the controller 160 can output the composite attribute defined for the background, e.g., the attribute control matrix interface capable of simultaneously adjusting the brightness and the contrast to the display unit 140, for example. Thereafter, the controller 160 can simultaneously adjust the brightness and contrast of the background based on a composite attribute control value selected according to an input signal or a touch event that a user generates. The controller 160 can support not only the background but also various user functions of the portable device 100, e.g., the composite attribute control such as an audio file playing function, a video file playing function, and a camera function. The description of composite attribute control of such functions is described in detail with reference to the following exemplary screen displays.

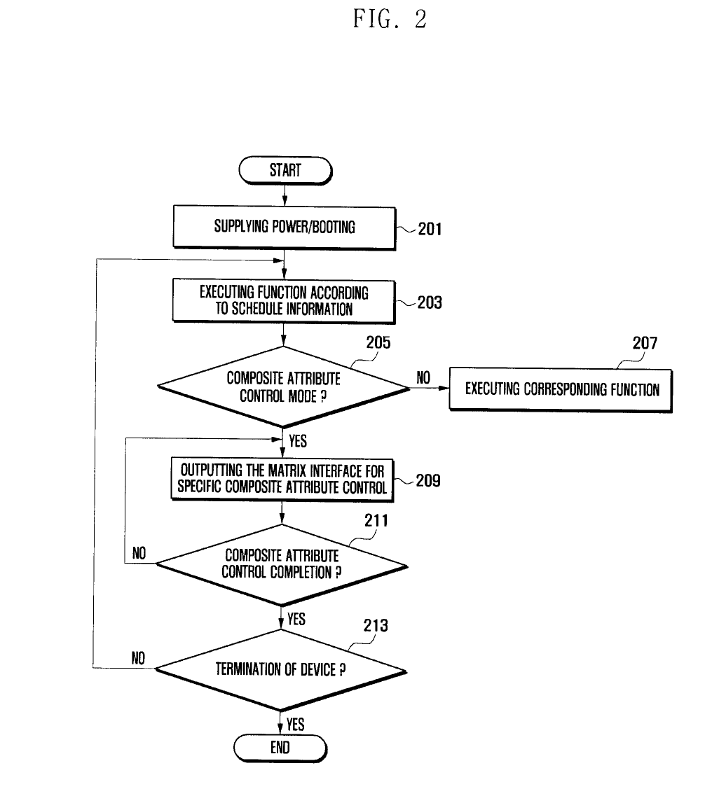

As describe above, the portable device 100 supporting the composite attribute control according to an exemplary embodiment of the present invention provides control of attributes of specific user function supported by an application program in a manner that is convenient and intuitive. Hereinafter, the composite attribute control method of the present invention based on the portable device 100 is described in detail with reference to FIG. 2.

FIG. 2 is a flowchart illustrating a composite attribute control method according to an exemplary embodiment of the present invention

In the composite attribute control method of the present invention, a user can perform the operation for supplying a power to the portable device 100. User may connect a battery or a battery charger of the portable device 100 and generate an input signal to supply electric power. In the meantime, when the power is supplied, the portable device 100 generates a power required for the operation of each configurations of the portable device 100 by using the provided power, initializes each configuration by using the generated power, and performs a booting operation (201). The portable device 100 executes a function according to preset schedule information when the booting process is completed (203), and may display a screen according to a corresponding function on the display unit 140. For example, according to preset schedule information, the portable device 100 may activate the application program configuring a background, and may output the background image to the display unit 140 according to the activation of a corresponding application program. Here, according to preset schedule information, the portable device 100 may activate the application program for the support of a camera function, and, accordingly, may output a preview screen according to the activation of camera function to the display unit 140. That is, the preset schedule information provides information that is formed to activate at least one user function that the portable device 100 can support.

Hereinafter, for the convenience of illustration, it is representatively illustrated that the screen corresponding to the music file playing player is outputted to the display unit 140 according to the activation of audio file playing program at step 203. That is, it is assumed that the portable device 100 activates the music file playing player at step 203, outputs a corresponding screen to the display unit 140, activates the previously registered music file according to a preset schedule, and outputs an audio signal corresponding to a pertinent music file through the audio processing unit 130. Then, the portable device 100 checks the entering of the composite attribute control mode (205). To this end, the portable device 100 can output an attribute control icon to one side of the screen for the entering of composite attribute control mode at step 203. Then, the portable device 100 can check for a generation of an input signal or a touch event selecting the attribute control icon for the entering of composite attribute control mode at step 205.

In this process, when an input signal or a touch event for the entering of a separate composite attribute control mode is not generated, the portable device 100 can maintain a corresponding function, e.g., the execution of function according to the schedule information performed at step 203, or perform a user function according to the received input signal or touch event (207). That is, according to the input signal or the touch event, the portable device 100 may terminate the execution of a music file play function and may perform the background output function, or may perform the menu screen output function. In the meantime, when the input signal or the touch event for the entering of composite attribute control mode is generated at step 205, the portable device 100 can output the matrix interface for the composite attribute control of the music file playing player (209).

Here, before proceeding to step 209 from step 205, the portable device 100 may check whether composite attributes defined in the activated music file playing player are plural, and may directly enter step 209 from step 205, when it is singular. However, when the composite attributes are plural, the portable device 100 outputs the menu screen which can select one of the composite attributes to the display unit 140. Thereafter, when the input signal or the touch event by which user selects a specific composite attribute is generated, the portable device 100 may output the matrix interface for the selected specific composite attribute control (209).

Here, briefly illustrating the attribute control matrix interface, in the attribute control matrix interface, a plurality of attributes are arranged on a specific location of a matrix, e.g., on the vertical horizontal central axis of matrix to form a virtual axis, and a change value of the attributes corresponding to each axis is arbitrarily defined in given areas divided by the virtual axis. Accordingly, when a user selects a specific spot or location on the matrix interface, the attribute control matrix interface complexly may control the attribute value of the axes corresponding to the pertinent spot or location, and may send a corresponding composite attribute control value to the controller 160.

In the meantime, after step 209, the portable device 100 checks whether the composite attribute control value selection is completed (211). In this process, when the composite attribute control is not completed, it returns to step 209 to repetitively perform the next steps. When the input signal or the touch event indicating the completion of composite attribute control is generated at step 211, the portable device 100 may check for the termination of the device (213). When a separate input signal for the termination of the device is not generated at step 213, the portable device 100 returns to step 203 to repetitively perform the next steps, and may support to the control of the attributes of the activated music file playing player. Here, the composite attributes defined in a specific application program of the portable device 100 are defined as a composite attribute by a designer, or may support a new setting or a presetting change by user.

To this end, the portable device 100 may support the setting screen for the attribute control so that the composite attribute of the attributes of the specific application program may be integrated or the composite attributes are re-defined as an individual attribute. Then, through the setting screen for the attribute control, a user integrates the composite attribute defined in a specific application program, e.g., the music file playing player, or may redefine a value previously defined as composite attributes as individual attribute(s).

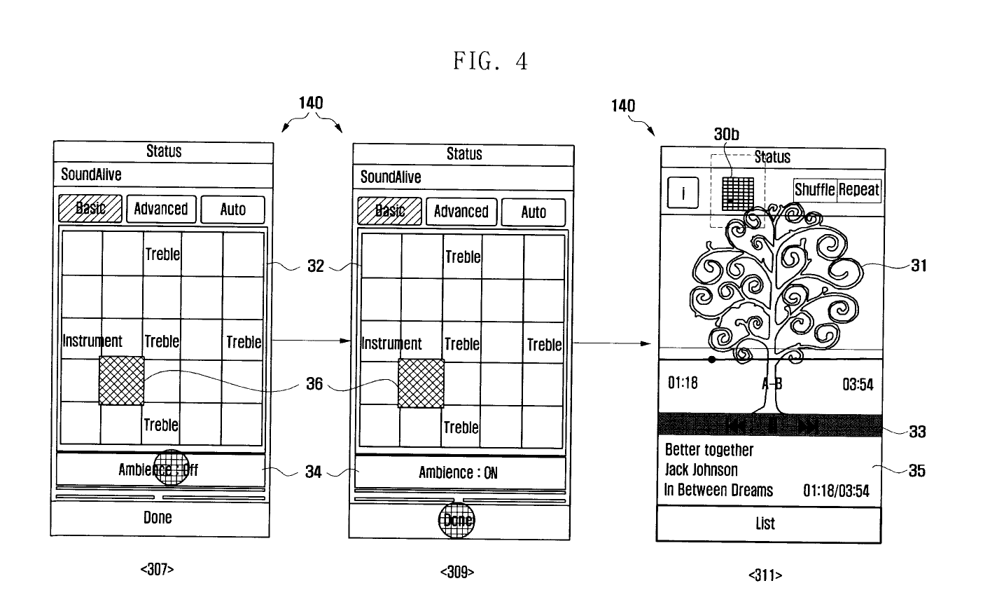

As described in the above, the composite attribute control method according to an exemplary embodiment of the present invention complexly controls attributes based on at least one composite attribute defined in a specific application program so that it supports the user to rapidly and easily perform the attribute control. FIGS. 3 and 4 are examples of screen for illustrating an audio composite attribute control according to an exemplary embodiment of the present invention.

Referring to FIGS. 3 and 4, for the audio composite attribute control of the present invention, when a user controls the portable device 100 to play a music file which is stored in the storage unit 150, or to receive a music file from a web server or other portable device to play, the display unit 140 may output a screen for the playing of a corresponding music file as illustrated by screen 301. At this time, the display unit 140 may include an image area 31 which outputs an album screen that is linked with music file or stored with music file to the display unit 140, a control key map area 33 which outputs a control key map for the control of playing of music file, and an information output area 35 outputting information related with music file currently being played. In the state where the screen 301 is outputted, when a user attempts to perform the composite attribute control of the present invention, a screen which includes the attribute control icon 30a (screen 303), may be presented to the user. For example, the user can control the portable device 100 by touching a designated area among the image area 31 of the display unit 140, to generate a corresponding input signal. Then, the portable device 100 can output the attribute control icon 30a on one side of the screen, as shown in screen 303. At this time, the portable device 100 can “pause” the playing music file, as shown in the drawing. Moreover, the portable device 100 may form a screen that includes the attribute control icon 30a while not performing a separate pause function. The attribute control icon 30a can be formed to indicate the composite attribute value which is currently set.

In the meantime, when an input signal or a touch event for selecting the attribute control icon 30a is generated in screen 303, the portable device 100 can output the attribute control matrix interface 32 which can perform the composite attribute control, as shown in screen 305 to the display unit 140. In screen 305, the portable device 100 can output the attribute control matrix interface 32 that can adjust a treble and a bass control, and an instrument and a vocal attribute at a time to the display unit 140. The portable device 100 can indicate the composite attribute state of the activating application program on the attribute control matrix interface 32. That is, the portable device 100 may express a set composite attribute state area 36 differently from other areas on the attribute control matrix interface 32, thereby indicating the current state of the composite attribute. In screen 305, user can touch a given area to relatively emphasize the instrument and the bass components of the musical composition in comparison with the treble and the vocal of the musical composition. Then, the portable device 100 sets the composite attribute state area 36 as an area that emphasizes the instrument and the bass, as shown in screen 307 (FIG. 4) so that the user may control the attribute. Here, the portable device 100 may continuously generate the music file generated in screen 301. The portable device 100 may apply the attribute value change to the generating music file on a real time basis so that the audio signal, which emphasized the instrument and the bass, may be outputted through the audio processing unit 130. In the meantime, in screen 305 or screen 309, the portable device 100 can provide an option area 34 that can set a specific audio effect, e.g., “Ambience” effect, to one side of the screen as the option of the audio attribute change. Then, when the “Ambience” option is “off” state, a user generates a specific input signal and may change the attribute of corresponding area into an “on” state, as shown in screen 309. When the composite attribute control and the audio option effect setting are completed and a user generates an input signal or a touch event corresponding to the completion at the procedure of screen 309, the portable device 100 may output an audio signal to which the composite attribute and audio option effect are applied, and output a screen which includes an image area 31 related with the activated music file, a control key map area 33, and information output area 35 to the display unit 140 as shown in screen 311. At this time, the portable device 100 can output the attribute control icon 30b to one side of the screen (screen 311). The attribute control icon 30b may display the image in which the changed composite attribute control value is expressed. That is, when compared with screen 303, the attribute control icon 30b may differently display the location of the composite attribute state area 36 indicating the composite attribute set value. In other words, when the composite attribute is controlled on the attribute control matrix interface 32, the image, which the attribute control icon 30b indicates, may be changed to show that the composite attribute is controlled.

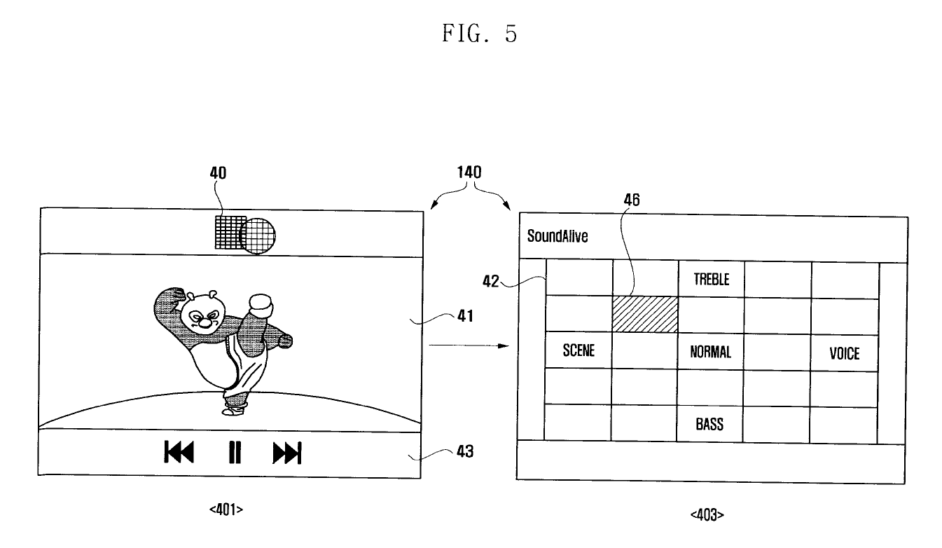

FIG. 5 is a screen for illustrating another example of an audio composite attribute control according to an exemplary embodiment of the present invention

Referring to FIG. 5, the portable device 100 may represent video screen area 41 playing a video file, a video playing control key area 43 and a display unit 140 which outputs an attribute control icon 40. In more detail, user can control to select and activate the video file stored in the storage unit 150 of the portable device 100, or to receive and play the video file received from a web server, a broadcast station, and other portable device. Then, the portable device 100 may play a corresponding video file, according to a user control, as an output to the video screen area 41 of the display unit 140. In addition, in the state where the video screen area 41 is outputted to the entire of the display unit 140, the user may attempt to perform control of the video playing or to perform the composite attribute control so that the user may generate a corresponding input signal or a touch event. Then, the portable device 100 may “pause” the activated video or continuously play the video-like screen 401, and, as shown in the drawing, may output the playing control key area 43 and the attribute control icon 40 to one side of the screen.

In the state of screen 401, when user generates an input signal or a touch event for selecting the attribute control icon 40, the portable device 100 can output the attribute control matrix interface 42 to the display unit 140, as shown in screen 403. Here, the attribute control matrix interface 42 controls the composite attribute of the audio file included in the video file, and controls the treble, the bass, the scene and voice attribute, for example. In case a corresponding sound is desired to be treated with treble, while a background music related with a scene or other background audio are emphasized based on an “Normal” area placed in the center of the attribute control matrix interface 42, a virtual line segment joining each attributes is divided by axis so that the matrix area is classified into four quadrants. For example, the upper right area is designated as quadrant I and, in a counter-clockwise direction, quadrant II, quadrant III, and quadrant IV, the user of portable device 100 can set a given area of quadrant II as the composite attribute state area. Moreover, when desiring to process a sound relating to a voice among the audio file of the video file with treble, the user can set a given area of quadrant I as the composite attribute state area 46. Here, the composite attribute state area 46 may be set by the operation that the user touches and designates a given area among the matrix area of a corresponding quadrant, and may be selected by setting a given area through using the input unit 120. As illustrated in the above, the portable device 100 supporting the composite attribute control according to an exemplary embodiment of the present invention may control the attributes of a specific audio signal in association with the corresponding application program.

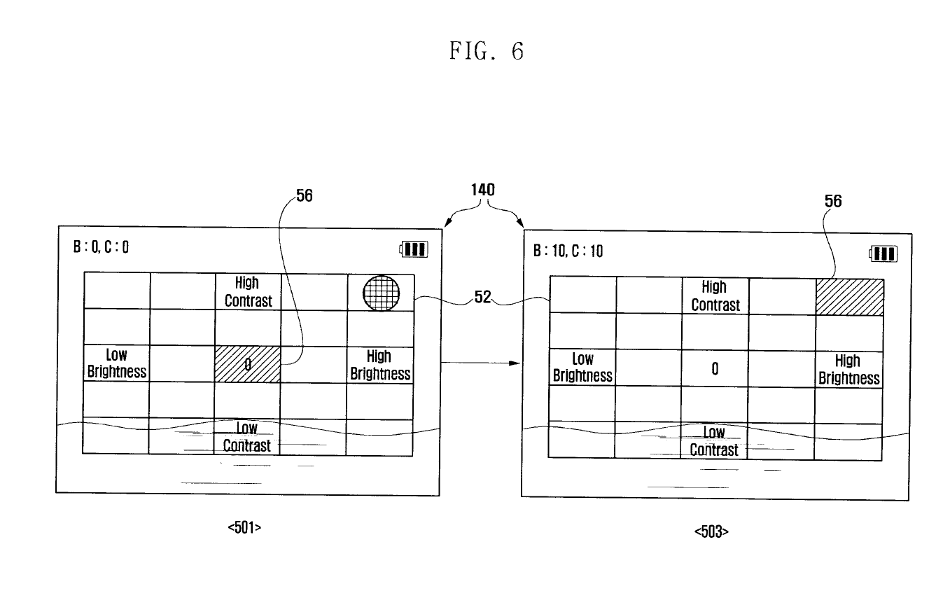

FIG. 6 is a screen for illustrating an example of a screen composite attribute control according to an exemplary embodiment of the present invention

Referring to FIG. 6, the portable device 100 of the present invention may output an attribute control matrix interface 52 that can control the brightness attribute and the contrast attribute. In more detail, when user generates an input signal for activating a specific application program, e.g., an application program for outputting a background, an application program for outputting an image, or an application program for outputting a video, the portable device 100 may activate a corresponding application program according to a user control. Then, according to the activation of application program, the portable device 100 may output a background, a specific image or a specific video to the display unit 140. At this time, the portable device 100 can output an attribute control icon for controlling attributes defined in the activating application to one side of the screen. The portable device 100 user may generate an input signal selecting the attribute control icon outputted in the screen, and the portable device 100 may output the attribute control matrix interface 52 which may control a specific attribute according to the selection of attribute control icon like screen 501. Particularly, the portable device 100 may output the attribute control matrix interface 52 which may simultaneously control the brightness and the contrast among the background, the image or the attributes of the video. In this procedure, as shown, the portable device 100 may indicate a set composite attribute value of the activating application program on the attribute control matrix interface 52. For example, when the defined composite attribute is an initial value, the portable device 100 may support in such a manner that the area indicated as “0” in the attribute control matrix interface 52 is highlighted.

In the meantime, the portable device 100 user may touch the right edge area among the area of the attribute control matrix interface 52 so as to have the highest brightness while having the highest contrast ratio in the composite attribute control. Then, the portable device 100 may designate the composite attribute state area 56 as the right edge area of the attribute control matrix interface 52 according to the touch of user like screen 503. At the same time, the portable device 100 may control the composite attribute of the brightness and the contrast of the activating application program. When an input signal for the completion of the composite attribute control is generated, the portable device 100 outputs a screen supporting the activating application program to the display unit 140, while outputting a screen applying the above-described composite attribute control. The portable device 100 may output the attribute control icon to one side of the screen applying the composite attribute control, and the attribute control icon may be an icon applying a new composite attribute control value. In the meantime, the portable device 100 may output the composite attribute control value to one side of the screen, e.g., the left upper end of the screen, so that the set composite attribute value may be recognized as a number, for example.

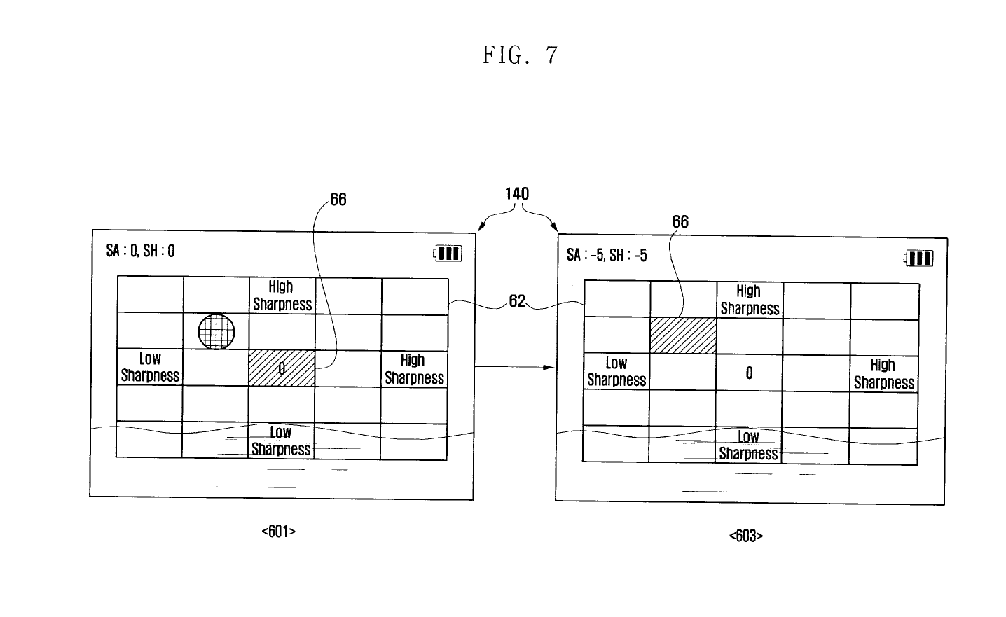

FIG. 7 is a screen for illustrating another example of a screen composite attribute control according to an exemplary embodiment of the present invention

Referring to FIG. 7, the portable device 100 may output the attribute control matrix interface 62 that can simultaneously control the chroma and the sharpness. To this end, as illustrated in FIG. 6, the portable device 100 outputs the screen for the support of the activating application program, and, at this time, outputs the attribute control icon for the output of the attribute control matrix interface 62. When an input signal selecting the attribute control icon is generated, the portable device 100 may output the attribute control matrix interface 62 which can control the attribute of the chroma and the sharpness to the display unit 140, as shown in screen 601. Here, the attribute control matrix interface 62 can indicate the composite attribute value of the activating application, e.g., “0” value. When the user touches a specific area of the attribute control matrix interface 62, e.g., an area which is set to have a relatively high chroma and sharpness, the portable device 100 sets the touch area as the composite attribute state area 66, and may send the value allocated to a corresponding area to the controller 160. Then, the controller 160 checks the set value allocated to the composite attribute state area 66, and may apply the chroma and the sharpness of the activating application program based on corresponding set values. The portable device 100 digitally displays the chroma and the sharpness value in one side of the screen, so that the use can recognize the composite attribute value set by user. As illustrated in FIGS. 6 and 7, the function for the composite attribute control according to an exemplary embodiment of the present invention can immediately modify and apply the composite attribute such as brightness/contrast and chroma/sharpness of the screen image outputted to the display unit 140 according to user input.

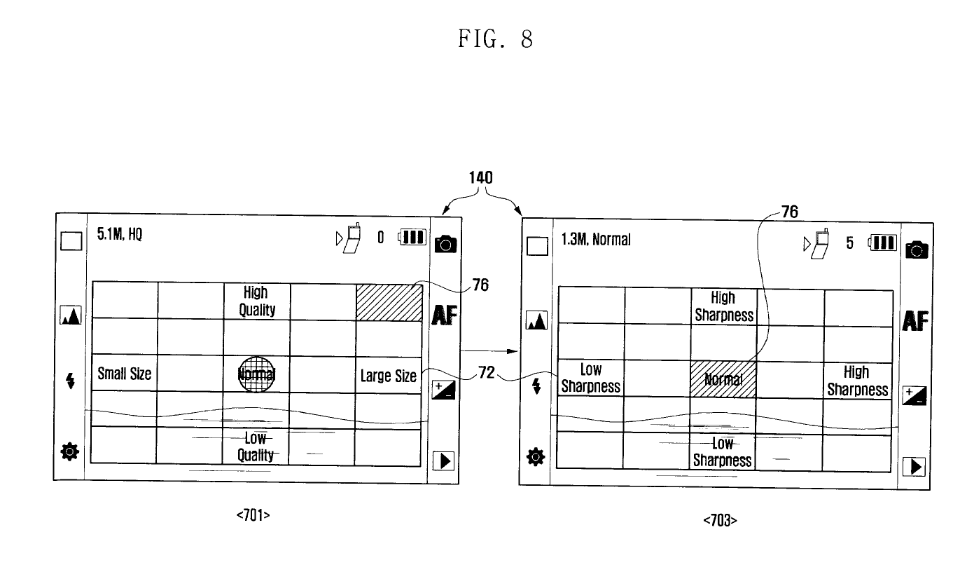

FIG. 8 is a screen for illustrating an example of a camera composite attribute control according to an exemplary embodiment of the present invention.

Referring to FIG. 8, the portable device 100 of the present invention may output the attribute control matrix interface 72 controlling the attribute of picture quality and size among the camera 170 attribute to the display unit 140. To this end, the portable device 100 may include a camera 170. User may generate an input signal for activating the camera 170 controlled by the portable device 100. The portable device 100 loads a program stored in the storage unit 150 for the operation of camera, and may output a preview screen according to the activation of camera 170 to the display unit 140 after the camera 170 is activated.

In this procedure, the portable device 100 may output the attribute control icon which can call the attribute control matrix interface 72 so as to perform the composite attribute control in one side of the preview screen. When an input signal or a touch event for selecting the attribute control icon is generated, the portable device 100 may output the attribute control matrix interface 72 to control the attribute of picture quality and size to the display unit 140 as shown in screen 701. Here, the portable device 100 may indicate the attribute of picture quality and size of the set camera 170, e.g., the state set with the highest sharpness and the maximum size as the composite attribute state area 76 in the attribute control matrix interface 72. Moreover, the portable device 100 may output the set composite attribute state to one side of screen, e.g., “5.1M, HQ”, as shown in the left upper end of the screen, so that user may recognize the state through character. Moreover, the portable device 100 may report the number of picture to be photographed based on the set picture quality and size in one side of the screen. That is, the portable device 100 checks a spare space of the storage unit 150, and may indicate the number of the pictures that can be stored according to the setting of picture quality and size of the set camera as “0”, as shown in one side of the screen, e.g., in the left upper end of the screen. The user can recognize that no pictures that can be photographed and stored by using the set picture quality and size.

When a user generates an input signal or a touch event for controlling the attribute of picture quality and size of the portable device 100, as shown in screen 701, the portable device 100 controls an area selected according to the touch event of user as the composite attribute state area 76, and may control the controlled value as the attribute of picture quality and size of the camera 170. That is, the portable device 100 controls the attribute of picture quality and size as a “Normal” state (screen 703), and highlights a corresponding area, so that it may indicate the designation of the composite attribute state area 76. The portable device 100 indicates the control value designated by “Normal” state in one side of the screen, e.g., the upper left, as “1.3M, Normal”, so that it may recognize the control value as a character.

Moreover, the portable device 100 may indicate, as shown in drawing, the number of pictures that can be stored according to the set attribute of picture quality and size as “5”. Then, a user is able to know that the number of picture which can be photographed and stored based on the set picture quality and size is added to five through the value outputted in one side of the screen.

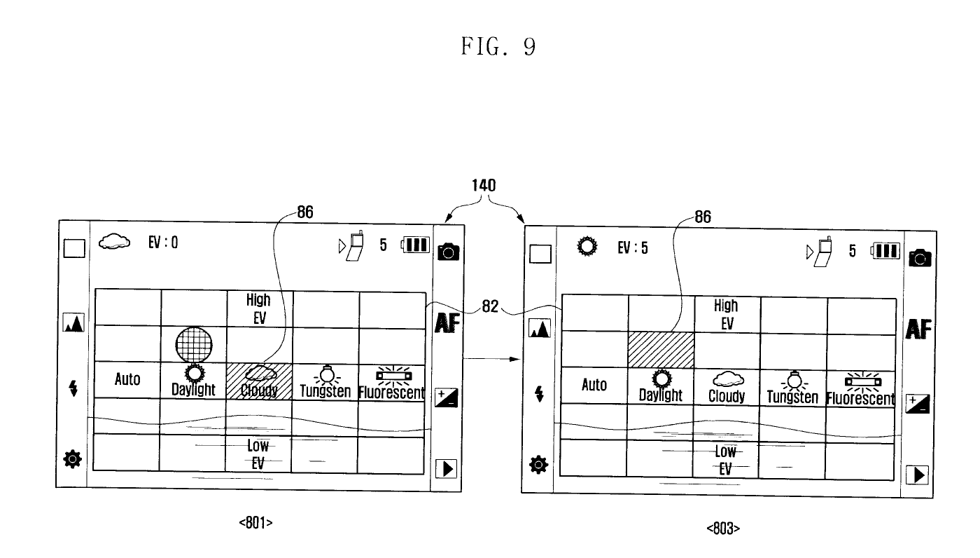

FIG. 9 is a screen for illustrating another example of a camera composite attribute control according to an exemplary embodiment of the present invention.

Referring to FIG. 9, the portable device 100 of the present invention may output an attribute control matrix interface 82 that can control the attribute of white balance and EV (electronic exposure) among the attribute of camera 170. To this end, as illustrated in FIG. 9, the portable device 100 may activate the camera 170 and to output a screen according to the activation of camera 170 to the display unit 140. When an input signal or a touch event for the call of attribute control matrix interface 82 is generated, the portable device 100 may output the attribute control matrix interface 82 which can control the white balance and the EV attribute (screen 801). Here, the attribute control matrix interface 82 in screen 801 may output an area including icons that can select various conditions for the white balance. That is, the attribute control matrix interface 82 has the attribute-select value of automatic, “Daylight”, “Cloudy”, “Tungsten”, “Fluorescent” for the white balance in the direction of horizontal axis, and can indicate the attribute value that can control the fluctuation of EV in the direction of vertical axis. In the state where the attribute control matrix interface 82 (screen 801) is outputted, a user may touch an area as shown so as to select the EV value higher than a “Daylight” white balance attribute, and a Normal state, and lower than a High state. When the touch event touching a given area is generated, (screen 803), the portable device 100 controls the area in which the touch event is generated as the composite attribute state area 86, and may apply the attribute value set in the controlled area as the attribute value of the camera 170.

In the meantime, when a new control value is generated in the state where the white balance and the EV attribute of previous set state are outputted to the left side of screen state in a character or icon type, the portable device 100 may renew and indicate the generated white balance and EV attribute value on a corresponding area. In this procedure, as shown in drawing, the portable device 100 may indicate the number of pictures photographed and stored according to the number of set white balance and EV values or the attribute setting of other camera 170 in one side of the screen with a given number, e.g., “5”.

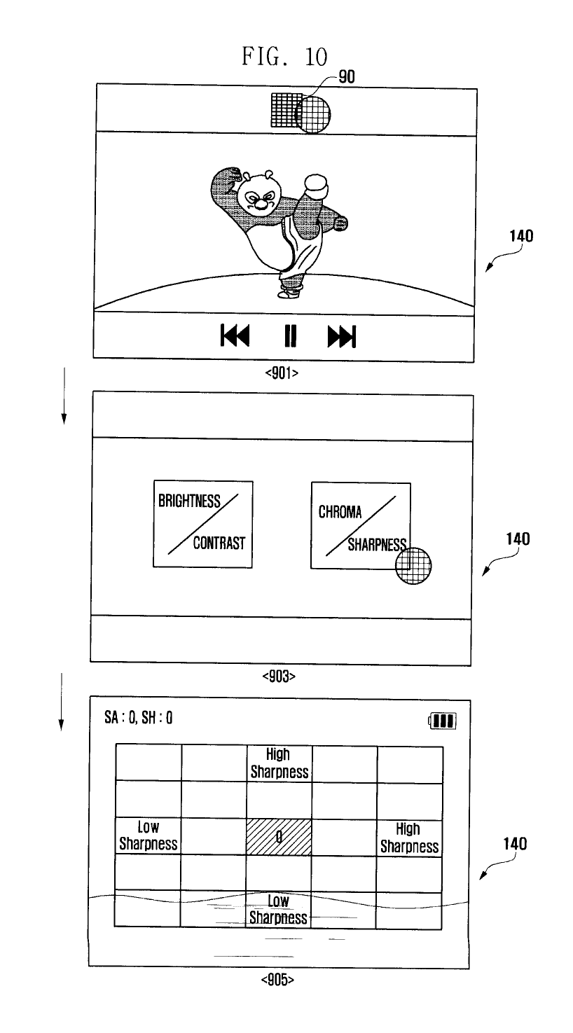

FIG. 10 is a screen for illustrating an example of a function of selectively using a plurality of composite attributes according to an exemplary embodiment of the present invention.

Referring to FIG. 10, the portable device 100 of the present invention may output a screen according to a specific application program, e.g., the play of video or image to the display unit 140. At this time, the screen outputted to the display unit 140 may include an attribute control icon 90 for the activation of the attribute control matrix interface (screen 901). Alternatively, in the state where the playing of video or image is performed, the portable device 100 may output the attribute control icon 90 to the display unit 140 according to a separate input signal or a specific touch event. When a signal for selecting the attribute control icon 90 is generated, the portable device 100 may check whether composite attribute defined in the activating application program is singular or plural. Here, when the composite attribute is singular, the portable device 100 may output the attribute control matrix interface to the display unit 140 (screen 905) and as illustrated in FIG. 3 to FIG. 8. Hence, when the composite attribute is plural, the portable device 100 may output a menu screen or a pop-up screen that can select one among a plurality of composite attributes (screen 903). For instance, the portable device 100 may output a screen which can select one among the composite attribute of brightness/contrast, and chroma/sharpness to the display unit 140. When user selects a corresponding menu item so as to control the composite attribute of chroma/sharpness, the portable device 100 may output the attribute control matrix interface for the control of chroma/sharpness to the display unit 140 like screen 905.

In the meantime, in the above-described description, screen 903 illustrates the capable of selecting one composite attribute among the composite attribute of brightness/contrast and chroma/sharpness. However, but the present invention is not limited thereto. That is, when the activating application program is a camera operating program, the portable device 100 may output a menu screen to control composite attributes among various attributes of the camera 170. In other words, the portable device 100 may output a menu screen that can select one among the composite attribute of picture quality/size, and white balance/EV, and to output the attribute control matrix interface shown in FIGS. 7 and 8 to the display unit 140 according to the selection of user. And, in the above-described description, the attribute control of brightness/contrast, and chroma/sharpness of the screen was illustrated in association with image and video, such composite attribute is able to be applied to the attribute control of a camera. Accordingly, a menu screen which supports to select one of the composite attributes in the control of composite attributes of the camera 170 function may include items in such a manner that one of the composite attributes of picture quality/size, white balance/EV, brightness/contrast, and chroma/sharpness is selected.

Thus the attribute control matrix interface illustrated in the FIGS. 3 to 9, according to the activation of a corresponding application and the selection of user, the attribute control matrix interface may include and output a matrix including the attribute control axis of treble and bass and the attribute control axis of musical instrument and vocal illustrated in FIGS. 3 and 4, a matrix including the attribute control axis of treble and bass and the control axis of scene and voice illustrated in FIG. 5, a matrix including the attribute control axis of brightness and the attribute control axis of contrast illustrated in FIG. 6, a matrix including the attribute control axis of chroma and the control axis of sharpness illustrated in FIG. 7, a matrix including the control axis of picture quality and the control axis of size illustrated in FIG. 8, and a matrix including the control axis of white balance and the control axis of electronics exposure illustrated in FIG. 9. Moreover, in the above-described description, it was illustrated that the attribute control icon is outputted to one side of the screen to call the attribute control matrix interface, but the present invention is not limited thereto. That is, the portable device 100 may assign the function of assigning the attribute control matrix interface to a specific key among input unit to configure a hotkey. Moreover, according to a specific touch event which is inputted from the touch panel 143, the portable device 100 may support the operation of the attribute control matrix interface. As described above, the composite attribute control function according to an exemplary embodiment of the present invention determines the kind of the activating application program, and may check the number of composite attributes defined in a corresponding application program. The composite attribute control function of the present invention may output the menu screen according to the number of composite attributes, or to immediately output the attribute control matrix interface for specific composite attribute control to the display unit 140. Accordingly, user can more simply and conveniently control various composite attributes of various application programs, and apply the controlled value to the activating application on a real time basis, so that user can easily determine the operation of controlled values.

The above-described portable device 100 can further include various modules according to the provision type. That is, the portable device 100 may further include elements which are not described in the above, such as a near field communication module in case of a communications terminal, an interface for data transmission and reception by a wire communications method or a wireless communications method of the portable device 100, an internet communications module communicating with an internet network and performing an internet function, and a digital broadcasting module performing the reception and playing function of digital broadcast. Because of to the trend of convergence of the digital device, the variation of these elements is too various to enumerate. However, the element equivalent to the above mentioned elements may be additionally included in the device. Moreover, in the above described configuration of the portable device 100 of the present invention, a specific element may be excluded or replaced with another element according to the provision type. It will be easily understood by those skilled in the art. Moreover, the portable device 100 according to an exemplary embodiment of the present invention may include all types of devices which can output the attribute control matrix interface for the control of composite attribute to the display unit. For instance, the portable device 100 may include all mobile communications terminals, multimedia devices and application devices thereof, such as a Portable Multimedia Player (PMP), a digital broadcasting player, a Personal Digital Assistant (PDA), a music player (e.g., MP3 player), a portable game terminal, a Smart phone, a notebook and a handheld PC as well as all mobile communications terminals operating based on communications protocols corresponding to various communications systems.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method, operable in a processor system, for controlling a composite attribute of a portable device, the method comprising:
receiving an input signal;
checking an application program activated according to the reception of the input signal;
outputting an attribute control matrix interface in which selected ones of a plurality of attributes associated with the application program are arranged based on a given axis of matrix; and
selecting at least one composite attribute defined in the application program.

2. The method of claim 1, further comprising:
simultaneously controlling composite attributes corresponding to given axes of the matrix according to a signal designating a given area of the attribute control matrix interface.

3. The method of claim 2, further comprising:
applying the controlled composite attribute to the activating application program on a real time basis.

4. The method of claim 2, further comprising:
outputting an attribute control matrix interface according to a generation of an input signal selecting the attribute control icon.

5. The method of claim 4, further comprising:
altering an image displaying the attribute control icon to indicate a controlled composite attribute value, when a composite attribute is controlled on the attribute control matrix interface.

6. The method of claim 1, further comprising:
checking a number of composite attributes defined in the application program; and
outputting a menu screen which can select ones among the plurality of composite attributes, when the number of composite attributes is plural.

7. The method of claim 6, wherein outputting an attribute control matrix interface comprises:
outputting an attribute control matrix interface that can control the composite attribute selected according to the selection of menu screen.

8. The method of claim 1, wherein, when the application program is an application program related with user function including an audio signal output function, outputting an attribute control matrix interface comprises at least one of:
outputting the attribute control matrix interface including an attribute control axis of treble and bass, and an attribute control axis of musical instrument and vocal; and
outputting the attribute control matrix interface including an attribute control axis of treble and bass, and a control axis of scene and voice.

9. The method of claim 1, wherein, when the application program is a camera operating program, outputting an attribute control matrix interface comprises at least one of:
outputting the attribute control matrix interface including an attribute control axis of brightness, and an attribute control axis of contrast;
outputting the attribute control matrix interface including an attribute control axis of chroma, and a control axis of sharpness;
outputting the attribute control matrix interface including a control axis of picture quality, and a control axis of size; and
outputting the attribute control matrix interface including a control axis of white balance, and a control axis of electronic exposure.

10. The method of claim 9, further comprising:
outputting number information area of pictures that can be photographed and stored according to composite attribute value changed depending on a setting or inputting signal.

11. A portable device comprising:
at least one of an input unit and a touch panel generating an input signal for a composite attribute control; and
a display unit outputting an attribute control matrix interface in which at least one composite attribute defined in an application program activated by a reception of the input signal is arranged based on a given axis of matrix.

12. The portable device of claim 11, further comprising a controller simultaneously controlling composite attributes corresponding to given axes of the matrix according to a signal designating a given area of the attribute control matrix interface.

13. The portable device of claim 12, wherein the controller applies the controlled composite attribute to the activating application program on a real time basis.

14. The portable device of claim 11, wherein the display unit outputs an attribute control icon associated with the attribute control matrix interface.

15. The portable device of claim 14, wherein the display unit outputs the attribute control matrix interface according to a generation of an input signal selecting the attribute control icon.

16. The portable device of claim 14, wherein the controller alters an image displaying the attribute control icon to indicate a controlled composite attribute value, when a composite attribute is controlled on the attribute control matrix interface.

17. The portable device of claim 11, wherein the controller checks a number of composite attributes defined in the application program, and outputs a menu screen that can select one among a plurality of composite attributes, when the number of composite attributes is plural.

18. The portable device of claim 17, wherein the display unit outputs an attribute control matrix interface, which can control a selected composite attribute, when a specific composite attribute is selected in the menu screen.

19. The portable device of claim 11, wherein the display unit, when the application program is an application program related with user function including an audio signal output function, outputs at least one of:
an attribute control matrix interface including an attribute control axis of treble and bass, and an attribute control axis of musical instrument and vocal; and
an attribute control matrix interface including an attribute control axis of treble and bass, and a control axis of scene and voice.

20. The portable device of claim 11, wherein the display unit, when the application program is a camera operating program, outputs at least one of:
an attribute control matrix interface including an attribute control axis of brightness and an attribute control axis of contrast;
an attribute control matrix interface including an attribute control axis of chroma, and a control axis of sharpness;
an attribute control matrix interface including a control axis of picture quality, and a control axis of size;
an attribute control matrix interface including a control axis of white balance, and a control axis of electronic exposure; and
a screen outputting a number information of pictures that can be photographed and stored according to composite attribute value changed based on a setting or inputting signal.
